(19) United States
(12) Patent Application Publication
(10) Pub. No.: US 2013/0226819 A1
(43) Pub. Date: Aug. 29, 2013

(54) MACHINE-BASED BUSINESS OBJECT VALIDATION

(71) Applicant: Alibaba Group Holding Limited, (US)

(72) Inventors: Jia Rong, Hangzhou (CN); Haifeng Zhu, Hangzhou (CN)

(73) Assignee: ALIBABA GROUP HOLDING LIMITED, George Town (KY)

(21) Appl. No.: 13/776,175

(22) Filed: Feb. 25, 2013

(30) Foreign Application Priority Data
Feb. 28, 2012 (CN) 201210048895.7

(51) Int. Cl. G06Q 30/00

(52) U.S. Cl. CPC G06Q 30/018
USPC 705/317

(57) ABSTRACT

Validating business objects is described, including: receiving from a client device associated with a requesting user a validation request associated with a business object; determining identification information associated with the business object from the validation request; obtaining historical data associated with the business object based at least in part on identification information associated with the business object, wherein the historical data includes data associated with one or more previous buyers of the business object; and selecting at least one previous buyer from the one or more previous buyers to validate the business object.

### CROSS REFERENCE TO OTHER APPLICATIONS

This application claims priority to People's Republic of China Patent Application No. 201210048895.7 entitled A BUSINESS OBJECT VALIDATION METHOD AND DEVICE, filed Feb. 28, 2012 which is incorporated herein by reference for all purposes.

### FIELD OF THE INVENTION

The present application relates to the field of Internet business technology. In particular, it relates to a technique of business object validation.

### BACKGROUND OF THE INVENTION

The Internet has come to play an increasingly important role in people's lives. People are able to acquire all kinds of information rapidly and in real time via the Internet. Internet applications have provided people with great convenience in their lives and in their work.

Because of its prevalence, the Internet has become a vehicle for business. Business that is realized via the Internet is generally called Internet business or electronic commerce (e-commerce). There are currently many types of Internet business that are accessible through websites, which are primarily supported on corresponding web servers. The services on such websites are mainly provided as follows: a user inputs information related to a business object (e.g., a product that the user wishes to sell at the website) at a user interface of a website and then the information is stored and then displayed at a webpage of the website so that other users may browse the information regarding the business object (e.g., and decide whether they wish to purchase the product). For example, if the business object is a physical item, then the descriptive information displayed on the webpage could be a picture of the physical object, its name, use, price, and other such information. In another example, if the business object comprises a service, the descriptive information displayed on the webpage could be a summary of, or key fields from, this service. If a user that browses the webpage with the descriptive information decides to proceed with a transaction, then the user may make an appropriate selection at the webpage. In response, the webpage may prompt the user to sign into the website and/or provide a form of payment.

Conventionally, when users browse business objects that are advertised on webpages, they primarily base their choice to purchase the business objects on the displayed descriptive information regarding these business objects. For example, a user may examine the business object's name, purpose, pictures, and other such information that are displayed on the webpage and then determine whether the business object meets his or her interests. In actual applications, there are large volumes of various business objects advertised for sale on the Internet and the descriptive information on the various business objects will generally be simple descriptions. The user may find it very difficult to gain a full understanding of the relevant facts of the business object from merely the descriptive information displayed at webpages. For example, a user who has not actually acquired the business object will be unable to determine the following about the business object that is described at the webpage: Is the business object defective? Are the pictures accurate? Is the descriptive information accurate? It is particularly difficult for a user to determine whether to buy a business object when he or she is not certain whether the advertised descriptive information contains false information.

### BRIEF DESCRIPTION OF THE DRAWINGS

Various embodiments of the invention are disclosed in the following detailed description and the accompanying drawings.

FIG. 1 is a diagram showing an embodiment of a system for validating a business object.

FIG. 2 is a flow diagram showing an embodiment of a process for validating a business object.

FIG. 3 is a flow diagram showing an embodiment of a process for selecting a communication mode to be established between a user associated with issuing a validation request and a selected previous buyer.

FIG. 4 is a flow diagram showing an embodiment of a process for selecting a communication mode to be established between a user associated with issuing a validation request and a selected previous buyer.

FIG. 5 is a diagram showing an embodiment of a system for validating business objects.

FIG. 6 is a diagram showing an embodiment of a system for validating business objects.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of machine-based validation of business objects are described herein. A validation request associated with a business object is received at a device (e.g., a server) from a user. As used herein, a business object refers to an object that is involved in a business transaction. For example, a business object may be a product or service that is being offered for sale at a webpage of an e-commerce website. The webpage may include descriptive information regarding the product or service that was submitted/input by a user who is selling/offering the product or service. A prospective buyer user who is browsing the webpage may become interested in purchasing the business object but is not sure if he can trust the descriptive information advertised of the business object or rely on the descriptive information's accuracy. Therefore, the user may submit a validation request associated with the business object. Identification information associated with the business object is determined from the received validation request. Historical data associated with the business object is determined. In various embodiments, the historical data includes identification information associated with one or more users who have previously purchased the business object. Contact information associated with at least one such previous buyer is determined and sent to the user so that the user may contact the previous buyer to receive information regarding the previous buyer's experience with the business object.

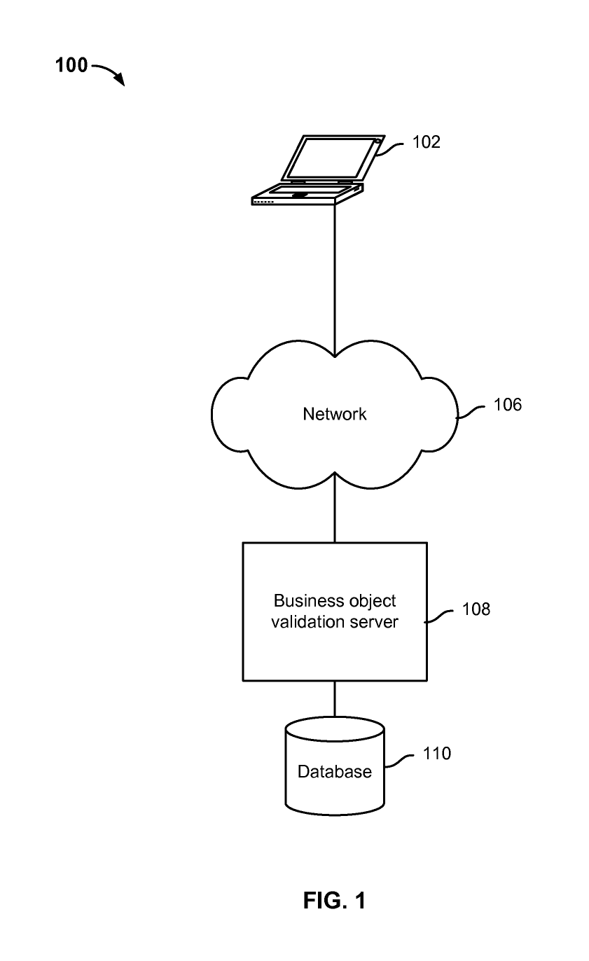

FIG. 1 is a diagram showing an embodiment of a system for validating a business object. In the example, system 100 includes device 102, network 106, business object validation server 108, and database 110. Network 106 includes high-speed data networks and/or telecommunications networks. Device 102 communicates to business object validation server 108 over network 106. In some embodiments, business object validation server 108 is associated with or is a component of a web server (not shown) associated with an e-commerce website.

A user may use device 102 to access an e-commerce website associated with business object validation server 108. While device 102 is shown to be a laptop, other examples of device 102 may include a desktop computer, a tablet device, a mobile device, a smart phone, and any other type of computing device. For example, a prospective buyer user may browse the e-commerce website using a browser or other application running on device 102 and come across a webpage associated with a particular business object that is for sale. Examples of the business object include a service or a product. The webpage may display descriptive information (e.g., descriptions, technical specifications, and images) associated with the advertised business object. The webpage may also include a selectable element such that if the prospective buyer of the business object clicks on the element, a validation request associated with the business object will be issued on behalf of the user.

While the prospective buyer may become interested in purchasing the business object as a result of reading the descriptive information, the prospective buyer may not be certain about the accuracy of such information. After all, the descriptive information was most likely submitted by another user who wishes to sell the business object and the information may not be entirely truthful and/or may exaggerate the good qualities of the business object. To receive validation information (e.g., other user's opinions) regarding the business object, the user may click on the selectable element at the webpage.

Business object validation server 108 is configured to receive and process the validation request sent from device 102. As will be described in more detail below, based on the information included in the validation request, business object validation server 108 is configured to determine one or more previous buyers of the business object and at least some of the previous buyers may be able to provide validation information to the user. In some embodiments, business object validation server 108 is configured to determine one or more previous buyers based on historical data associated with business objects stored at database 110. For example, validation information may include the previous buyer's own experience with the purchased business object.

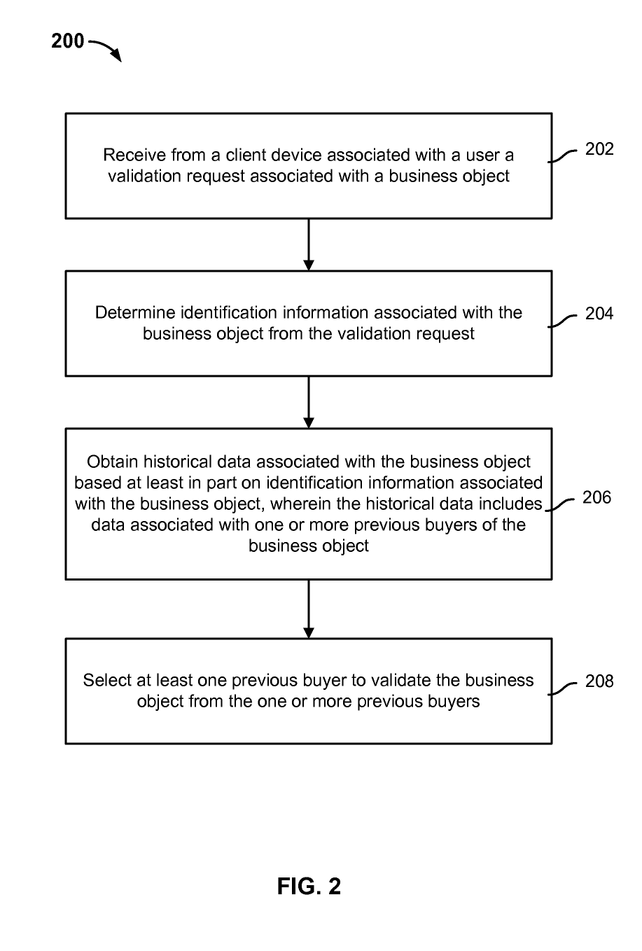

FIG. 2 is a flow diagram showing an embodiment of a process for validating a business object. In some embodiments, process 200 is performed at system 100.

In various embodiments, at an e-commerce website, a seller user may advertise for products or services that he is selling by submitting descriptive information related to each such business object (e.g., product or service) at a user interface associated with the website. The set of descriptive information associated with each business object may be stored and displayed at a corresponding webpage associated with advertising the business object. A set of descriptive information associated with a business object may include identification information associated with the business object, technical specifications of the business object, an image of the business object, and other information.

At 202, a validation request associated with a business object is received from a client device associated with a user. Another user (a prospective buyer user) looking to purchase business objects at the website may browse the webpage of a particular business object at a client device. However, because the descriptive information of the business object may be submitted by the seller user, the information may not be complete and/or may include information that the prospective buyer user cannot readily verify. For example, the descriptive information of the business object may claim that the battery life of the product is one month long. But without testing the product himself, the prospective buyer user is left to wonder if the claim about the battery life is reliable. Also for example, the image of the product in the descriptive information may show a very high quality product but the price of the product may be relatively low so the prospective buyer user may wonder if the actual product resembles the one depicted in the image. As such, in various embodiments, a selectable element (e.g., a button) may be displayed at each webpage associated with a business object such that the element may be selected by a user to validate the business object. In various embodiments, in response to a selection of the element associated with a business object, a validation request associated with the business object is issued on behalf of the prospective buyer user that selected the element. In various embodiments, validating a business object refers to determining information regarding the particular business object from relevant sources (e.g., previous buyers of the business object).

For example, assume that user Jack arrives at a webpage that advertises a ski jacket for sale. The descriptive information of the ski jacket claims that the ski jacket is very sturdy and keeps out the cold, especially in snowy conditions. Jack is very interested in the jacket, especially because the listed price of the jacket is very cheap compared to other jackets that he was considering buying. However, Jack is not certain that the descriptive information of the jacket is reliable, given the low price. To validate the ski jacket and its descriptive information, Jack clicks on the button on the webpage associated with validating the business object to generate a validation request which is received by the server.

At 204, identification information associated with the business object is determined from the validation request. In some embodiments, the validation request includes identification information associated with the business object. For example, the identification information of a business object may include an alphanumeric identifier, a product code, and a name associated with the business object. In some embodiments, the validation request also includes identification information associated with the prospective buyer user. For example, the user is a registered user of the e-commerce website and prior to selecting the selectable element associated with validating the business object, the user had signed into the website. As a result of the user having signed in, the identification information of the user may be obtained. Alternatively, in the event that the user was not signed in prior to selecting the selectable element associated with validating the business object, identification information associated with the user may be determined from cookie data stored at the user's client device.

At 206, historical data associated with the business object is obtained based at least in part on identification information associated the business object, wherein the historical data includes data associated with one or more previous buyers of the business object. In various embodiments, historical data is stored for each business object. The historical data of the business object associated with the validation request may be looked up using the obtained business object identification information. Historical data may include sets of descriptive information associated with the business object and data associated with past purchases of the business object (e.g., at the same website), for example. Data associated with past purchases of the business object may include when the business object was purchased and by which users. In various embodiments, a previous buyer refers to a user that has previously purchased the business object.

At 208, at least one previous buyer to validate the business object is selected from the one or more previous buyers. Identification of previous buyers of the business object may be determined from the historical data. The previous buyers may include users who have accounts (i.e., users who have registered) with the websites and users who do not have accounts (i.e., users who have not yet registered) with the website. Registered users may be identified based on the information that they submitted during registration and unregistered users may be identified based on IP addresses that they used, for example. In some embodiments, in the process of creating an account at the website (i.e., registration), a user is prompted to submit whether he or she would like to be contacted by prospective buyers of business objects among other information that is stored with the user's account information. In some embodiments, if the user indicates that he or she would like to be contacted by prospective buyers of business objects, then the user is prompted to submit preferred contact information associated with at least one particular mode of communication (e.g., email, voice, instant messaging).

In some embodiments, if there is only one previous buyer included in the historical data, then that previous buyer is determined to validate the business object. In some embodiments, if there is more than one previous buyer included in the historical data, then at least one previous buyer is selected based on a selection strategy to validate the business object.

Below are some example techniques associated with selecting one or more previous buyers to validate the business object:

### Selection Technique Embodiment 1

In this embodiment, the user associated with issuing the validation request may configure the number of previous buyers of the business object that he would like to have to validate the business object. For example, in response to the user clicking on the selectable element associated with validation of the business object, a prompt is presented to the user that asks the user to submit a number of previous buyers of the business object that the user would like to validate the business object. Or in another example, if the user associated with issuing the validation request is a registered user at the website, then the user may configure data within the user's profile settings associated with a desired number of previous buyers of a business object to validate the business object. Once the validation request is received and the historical data associated with the business object is determined, then the number of previous buyers associated with the business object may be determined from the historical data. In the event that the number of previous buyers configured by the user is fewer than the total number of previous buyers associated with the business object that are determined from the historical data, the number of previous buyers configured by the user is selected from the historical data to validate the business object. However, in the event that the number of previous buyers configured by the user is greater than the total number of previous buyers associated with the business object that are determined from the historical data, then the number of previous buyers to select to validate the business object may be determined based on a predetermined default value or determined dynamically by the system. In one example, the system dynamically determines to select all the previous buyers that are found in the historical data for the business object to validate the business object. In another example, the system dynamically determines a number of previous buyers to select based on the relative size of the previous buyer pool as determined from the historical data (e.g., if there is a relatively large number of previous users included in the historical data, then a larger number of previous buyers may be selected or if there is a relatively small number of previous users included in the historical data, then a smaller number of previous buyers may be selected). In another example, a predetermined proportion of the total number of previous buyers included in the historical data is randomly selected to validate the business object.

### Selection Technique Embodiment 2

In this embodiment, the previous buyers of the business object may be selected to validate the business object based on their respective user statuses. A user status may refer to any type of status that may be associated with a particular user. Below are some examples of different user statuses:

In the first example, the user status refers to whether the previous buyer user is currently online at the e-commerce website. In some embodiments, a user is referred to being online if he is currently signed in or logged onto the e-commerce website using his user account. In some embodiments, a user is referred to being online if he is currently signed into an instant messaging service that may be associated with the e-commerce website. In one example, the system determines whether a previous buyer is currently signed into the e-commerce website or instant messaging client based on checking his current online status associated with that user's account. In this example, each previous buyer that is currently online is selected to validate the business object.

In the second example, the user status refers to whether the previous buyer has configured in a setting to receive solicitations of business object validation. For example, a setting in each user's account may be configured by the user to indicate either that the user agrees to receive communications from prospective buyers of business objects or that the user does not agree to receive communications from prospective buyers of business objects. That is, not every user who has previously purchased a business object may be willing to be contacted by a prospective buyer to provide validation information regarding the business object for the prospective buyer. In this example, each previous buyer who has indicated in the setting that he is willing to participate in providing validation information is selected to validate the business object.

In the third example, the user status refers to how recently the user had purchased the business object. In some embodiments, a time period of a predetermined length may be configured such that only those previous buyers who had bought the business objects within the predetermined length of time from the current time may be selected to validate the business object. This way, only previous buyers who have purchased the business object sufficiently recently may be selected to provide validation information on the business object because they are more likely to recall their experience with respect to the business object.

In some embodiments, contact information associated with each of the selected previous buyer(s) is determined. For example, identification information of each selected previous buyer may be determined from the obtained historical data. Then, stored account information associated with the previous buyer may be obtained to determine preferred contact information associated with the previous buyer. For example, contact information may include an email address, a physical address, a phone number, or an instant messaging screen name. In some embodiments, the contact information associated with the previous buyer is sent to the user associated with issuing the validation request so that the user may reach out to the previous buyer to receive validation information on the business object. For example, the contact information of the selected previous buyer may be emailed to the user associated with the validation request. In various embodiments, validation information may include the previous buyer's opinion, comments, scores, rating, review, grade, and/or other feedback regarding the business object. It is assumed that the previous buyer has already received and/or even used the purchased business object. Thus, the user may get in touch with the selected previous buyer to receive the previous buyer's description of his experience with the business object that the user is interested in. In some embodiments, the user may even pose specific questions to the previous buyer. The previous buyer may candidly express his opinions to the user as validation information and the user may determine whether to proceed with buying the business object after receiving the validation information. For example, in the validation information, the previous buyer may express his opinion regarding the accuracy of the descriptive information of the business object as compared to the actual product or service that he received. In some embodiments, preferred contact information associated with the user associated with issuing the validation request is sent to the selected previous buyer so that the previous buyer may initiate contact with the user to provide his validation information.

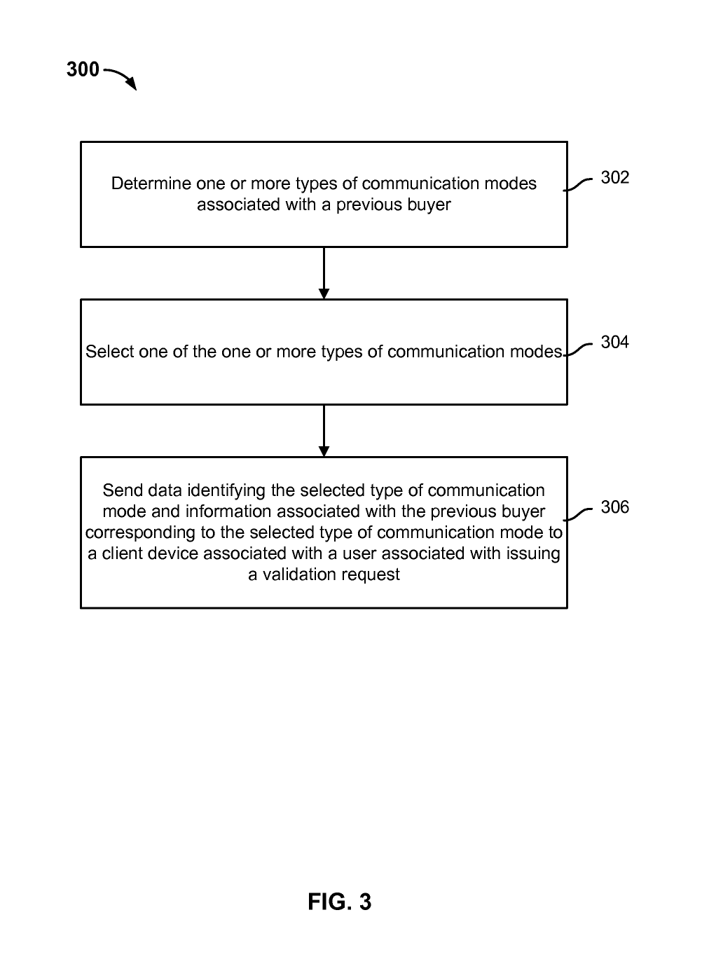

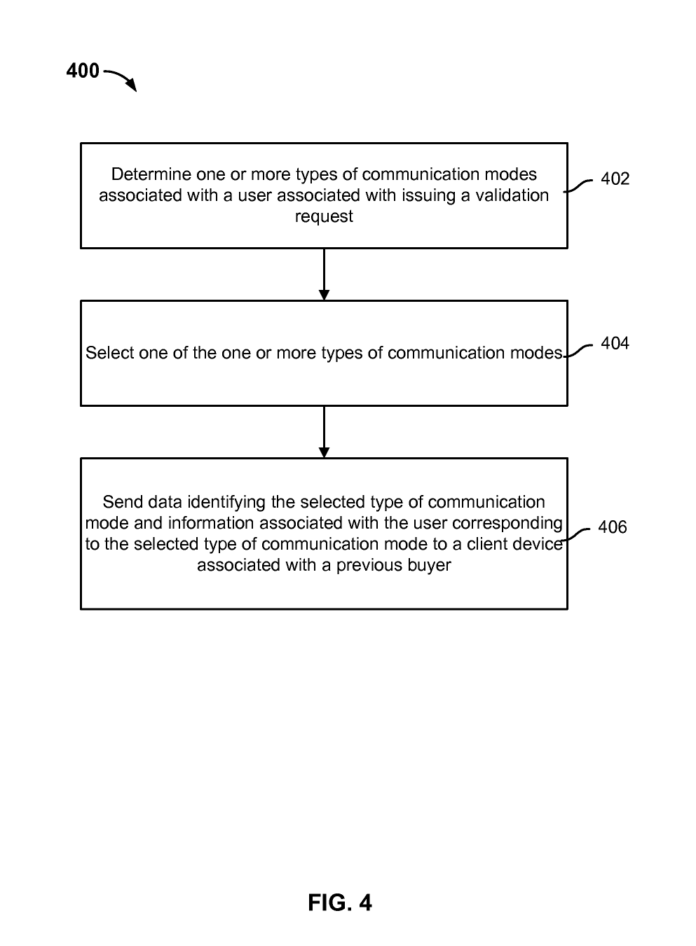

Once one or more previous buyers have been selected to validate the business object, FIGS. 3 and 4 describe establishing a communication link between the user associated with issuing the validation request and each previous buyer.

FIG. 3 is a flow diagram showing an embodiment of a process for selecting a communication mode to be established between a user associated with issuing a validation request and a selected previous buyer. In some embodiments, process 300 is implemented at system 100.

Process 300 may be performed for each previous buyer selected by a process such as process 200 to validate a business object. Process 300 shows an example of sending contact information associated with a previous buyer to the user who issued the validation request.

At 302, one or more types of communication modes associated with a previous buyer are determined. A type of communication mode associated with a previous buyer refers to a type of communication that the previous buyer is capable of using. Examples of communication modes include voice communication (e.g., over a phone), video communication, email communication, and instant messaging communication. In some embodiments, communication modes associated with a previous buyer may be determined based on the previous buyer's user account information, which may include the previous buyer's information associated with each type of communication mode that he uses. For example, in the account information, the previous buyer may have provided information such as his instant messaging identifier associated with the instant messaging communication mode, his phone number associated with the voice communication mode, his email address associated with the email communication mode, and his video account identifier associated with the video communication mode.

At 304, one of the one or more types of communication modes is selected. A particular type of communication mode (e.g., instant messaging, email, video, or voice) that is used by the previous buyer is selected (e.g., based on any configured basis).

At 306, data identifying the selected type of communication mode and information associated with the previous buyer corresponding to the selected type of communication mode are sent to a client device associated with a user associated with issuing a validation request. Data that indicates the selected type of communication mode (e.g., instant messaging, email, video, or voice) and the previous buyer's stored information corresponding to that communication mode (e.g., the previous buyer's instant messaging identifier, the previous buyer's email address, the previous buyer's phone number, or the previous buyer's video account identifier) are sent to a client device used by the user associated with issuing the validation request. For example, the client device may be the client device from which the validation device was issued. For example, the client device may be a mobile device or a computer.

The user associated with issuing the validation request will receive the data that identifies the type of communication mode selected for each previous buyer and the previous buyer's information for that particular type of communication mode. For example, if the selected type of communication mode was voice, then the user may receive a message that includes identification information associated with a previous buyer, an identifier associated with the voice communication mode, and the previous user's provided phone number. The user associated with issuing the validation request may then use the received message to contact that previous buyer by calling him at the provided phone number.

FIG. 4 is a flow diagram showing an embodiment of a process for selecting a communication mode to be established between a user associated with issuing a validation request and a selected previous buyer. In some embodiments, process 400 is implemented at system 100.

Process 400 shows an example of sending contact information associated with a user who issued the validation request to a selected previous buyer.

At 402, one or more types of communication modes associated with a user associated with issuing a validation request are determined. A type of communication mode associated with the user refers to a type of communication that the user is capable of using. Examples of communication modes include voice communication (e.g., over a phone), video communication, email communication, and instant messaging communication. In some embodiments, communication modes associated with the user may be determined based on the user's user account information, which may include the user's information associated with each type of communication mode that he uses. For example, in the account information, the user may have provided information such as his instant messaging identifier associated with the instant messaging communication mode, his phone number associated with the voice communication mode, his email address associated with the email communication mode, and his video account identifier associated with the video communication mode.

At 404, one of the one or more types of communication modes is selected. A particular type of communication mode (e.g., instant messaging, email, video, or voice) that is used by the user is selected (e.g., based on any configured basis).

At 406, data identifying the selected type of communication mode and information associated with the user corresponding to the selected type of communication mode are sent to a client device associated with a previous buyer. The previous buyer may be determined by a process such as process 200. Data that indicates the selected type of communication mode (e.g., instant messaging, email, video, or voice) and the previous buyer's stored information corresponding to that communication mode are sent to a client device used by the previous buyer selected to validate the business object associated with the validation request. For example, the client device used by the previous buyer may be the device at which the previous buyer is currently using to sign into the website. Or for example, the client device used by the previous buyer may be a device for which identifying information is included in the previous buyer's account information. For example, the client device may be a mobile device or a computer.

In some embodiments, in addition to the data identifying the selected type of communication mode and information associated with the user corresponding to the selected type of communication mode, identification information associated with the business object or the webpage address of the business object associated with the validation request is sent to the client device of the previous buyer. Such information regarding the business object may be sent to the previous buyer to give the previous buyer notice of the business object that a prospective buyer may contact him about.

The previous buyer may then use the received message to contact the user who issued the validation request at the selected type of communication mode to provide validation information regarding the business object associated with the request.

By enabling a prospective buyer (i.e., the user associated with issuing the validation request) of a particular business object to receive contact information associated with buyers that have previously purchased the business object and vice versa, the prospective buyer may receive information regarding actual past buyers of the business object's confirmation regarding the accuracy of the advertised descriptive information. No longer does the prospective buyer need to purchase the business object without knowing actual buyer feedback on the business object. The prospective buyer may establish a one-on-one communication with a previous buyer to discuss the business object. The feedback provided by previous buyers may reduce the prospective buyer's fear of uncertainty and risk in purchasing the business object. A prospective buyer may even contact multiple previous buyers to receive different accounts of purchases of the same business object. After receiving such validation information, the prospective buyer can make a very informed decision regarding whether to purchase the business object for himself.

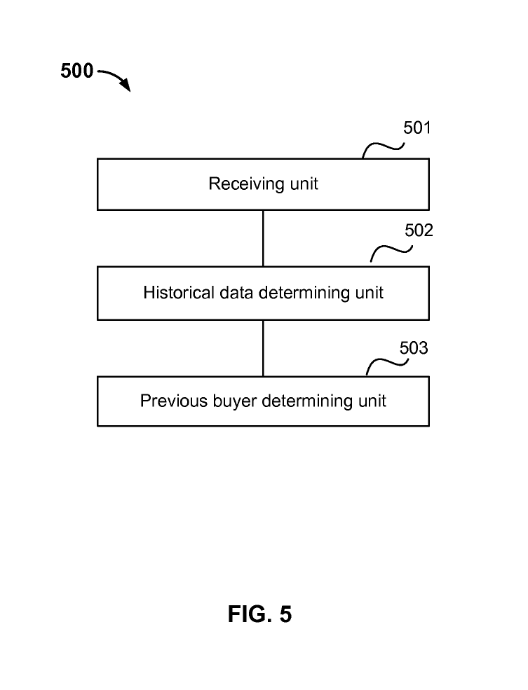

FIG. 5 is a diagram showing an embodiment of a system for validating business objects. In the example, system 500 includes receiving unit 501, historical data determining unit 502, and previous buyer determining unit 503. In some embodiments, system 500 is associated with or comprises a component of an e-commerce website server.

The units and elements can be implemented as software components executing on one or more processors, as hardware such as programmable logic devices and/or Application Specific Integrated Circuits designed to perform certain functions, or a combination thereof. In some embodiments, the units and elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and elements may be implemented on a single device or distributed across multiple devices.

Receiving unit 501 is configured to receive a validation request associated with a user with respect to a business object displayed on a web page. In some embodiments, the validation request includes identification information associated with the business object.

Historical data determining unit 502 is configured to obtain, based on the identification information associated with the business object in the validation request received by receiving unit 501, the stored historical data of the business object corresponding to the identification information. The historical data includes at least sets of descriptive information associated with the business object and data associated with historical purchases of the business object. Data associated with historical purchases include identification information associated with users that have previously purchased the business object and when the purchases occurred.

Previous buyer determining unit 503 is configured to determine one or more previous buyers of the business object based on the obtained historical data obtained by the historical data determining unit 502.

In some embodiments, previous buyer determining unit 503 is further configured to select one or more of the determined previous buyers to validate the business object based on a number of previous buyers that is configured by the user associated with issuing the validation request.

In some embodiments, previous buyer determining unit 503 is further configured to select one or more of the determined previous buyers to validate the business object based on the previous buyers' corresponding user statuses. For example, previous buyers that are determined to be currently online may be selected, previous buyers that are determined to have configured their settings to indicate that they are willing to participate in business object validation are selected, and previous buyers who have purchased the business object within a predetermined period of time before the current time are selected.

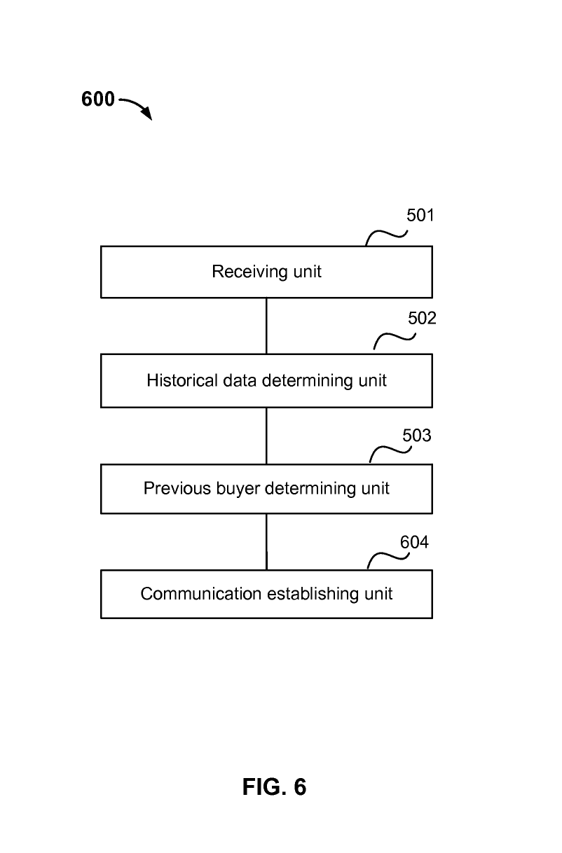

FIG. 6 is a diagram showing an embodiment of a system for validating business objects. In the example, system 600 includes receiving unit 501, historical data determining unit 502, previous buyer determining unit 503, and communication establishing unit 604. In some embodiments, system 600 is associated with or comprises a component of an e-commerce website server.

System 600 is similar to system 500 but includes an additional component, communication establishing unit 604. Because receiving unit 501, historical data determining unit 502, and previous buyer determining unit 503 are described above with system 500, only communication establishing unit 604 is described below.

Communication establishing unit 604 is configured to send contact information associated with the selected previous buyer(s) to a client device used by the user associated with issuing the validation request and/or send contact information associated with the user associated with issuing the validation request to the respective client devices used by the selected previous buyer(s). In some embodiments, communication establishing unit 604 is configured to select a particular type of communication mode used by the user associated with issuing the validation request and then send the user's contact information corresponding to that type of communication mode to the client device of each selected previous buyer. In some embodiments, communication establishing unit 604 is configured to select a particular type of communication mode used by each selected previous buyer and then send the previous buyer's contact information corresponding to that type of communication mode to the client device of the user associated with issuing the validation request.

In some embodiments, communication establishing unit 604 is configured to send to the client device of each selected previous buyer identification information and/or a webpage address associated with the business object associated with the validation request.

The units and elements can be implemented as software components executing on one or more processors, as hardware such as programmable logic devices and/or Application Specific Integrated Circuits designed to perform certain functions, or a combination thereof. In some embodiments, the units and elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units and elements may be implemented on a single device or distributed across multiple devices.

The embodiments described herein may be realized through computer programs. Persons skilled in the art should be able to understand that the module partition pattern described above is but one of a great number of module partition patterns.

A person skilled in the art should understand that the embodiments of the present application can be provided as methods, devices (equipment), or computer software products. Therefore, the present application can take the form of embodiments consisting entirely of hardware, embodiments consisting entirely of software, and embodiments which combine software and hardware. In addition, the present application can take the form of computer program products implemented on one or more computer-operable storage media (including but not limited to magnetic disk storage devices, CD-ROMs, and optical storage devices) containing computer operable program codes.

The present application is described with reference to flow charts and/or block diagrams based on methods, devices (equipment) and computer program products of the embodiments of the present application. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data processing equipment so as to give rise to a machine, with the result that the commands executed through the computer or processor of other programmable data processing equipment give rise to a device that is used to realize the functions designated by one or more processes in a flow chart and/or one or more blocks in a block diagram.

These computer program commands can also be stored on specially-operating computer-readable storage devices that can guide computers or other programmable data processing equipment, with the result that the commands stored on these computer-readable devices give rise to products that include command devices. These command devices realize the functions designated in one or more processes in a flow chart and/or one or more blocks in a block diagram.

These computer program commands can also be loaded onto a computer or other programmable data processing equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application. Obviously, a person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for validating business objects, comprising:
one or more processors configured to:
receive from a client device associated with a requesting user a validation request associated with a business object;
determine identification information associated with the business object from the validation request;
obtain historical data associated with the business object based at least in part on identification information associated with the business object, wherein the historical data to includes data associated with one or more previous buyers of the business object; and
select at least one previous buyer from the one or more previous buyers to validate the business object; and
one or more memories coupled to the one or more processors and configured to provide the one or more processors with instructions.

2. The system of claim 1, wherein the business object comprises a service.

3. The system of claim 1, wherein the business object comprises a product.

4. The system of claim 1, wherein the validation request is generated in response to a user selection of a selectable element associated with a webpage associated with the business object.

5. The system of claim 1, wherein the data associated with one or more previous buyers of the business object includes identification information associated with each of the one or more previous buyers and purchase times corresponding to the one or more previous buyers.

6. The system of claim 1, wherein selecting the previous buyer is determined based on a user status associated with the previous buyer.

7. The system of claim 1, wherein selecting the previous buyer is determined based on a configuration associated with the requesting user for a number of previous buyers to select to validate the business object.

8. The system of claim 1, wherein the one or more processors are further configured to:
determine one or more types of communication modes associated with the selected previous buyer;
select one of the one or more types of communication modes; and
send data identifying the selected type of communication mode and information associated with the selected previous buyer corresponding to the selected type of communication mode to the client device associated with the requesting user.

9. The system of claim 1, wherein the one or more processors are further configured to:
determine one or more types of communication modes associated with the requesting user;
select one of the one or more types of communication modes; and
send data identifying the selected type of communication mode and information associated with the requesting user corresponding to the selected type of communication mode to a client device associated with the selected previous buyer.

10. The system of claim 9, wherein the one or more processors are further configured to send is identification information or a webpage address associated with the business object to the client device associated with the selected previous buyer.

11. A method for validating business objects, comprising:
receiving from a client device associated with a requesting user a validation request associated with a business object;
determining, using one or more processors, identification information associated with the business object from the validation request;
obtaining historical data associated with the business object based at least in part on identification information associated with the business object, wherein the historical data includes data associated with one or more previous buyers of the business object; and
selecting at least one previous buyer from the one or more previous buyers to validate the business object.

12. The method of claim 11, wherein the validation request is generated in response to a user selection of a selectable element associated with a webpage associated with the business object.

13. The method of claim 11, wherein the data associated with one or more previous buyers of the business object includes identification information associated with each of the one or more previous buyers and purchase times corresponding to the one or more previous buyers.

14. The method of claim 11, wherein selecting the previous buyer is determined based on a user status associated with the previous buyer.

15. The method of claim 11, wherein selecting the previous buyer is determined based on a configuration associated with the requesting user for a number of previous buyers to select to validate the business object.

16. The method of claim 11, further comprising:
determining one or more types of communication modes associated with the selected previous buyer;
selecting one of the one or more types of communication modes; and
sending data identifying the selected type of communication mode and information associated with the selected previous buyer corresponding to the selected type of communication mode to the client device associated with the requesting user.

17. The method of claim 11, further comprising:
determining one or more types of communication modes associated with the requesting user;
selecting one of the one or more types of communication modes; and
sending data identifying the selected type of communication mode and information associated with the requesting user corresponding to the selected type of communication mode to a client device associated with the selected previous buyer.

18. The method of claim 17, further comprising sending identification information or a webpage address associated with the business object to the client device associated with the selected previous buyer.

19. A computer program product for validating business objects, the computer program product being embodied in a non-transitory computer readable storage medium and comprising computer instructions for:
receiving from a client device associated with a requesting user a validation request associated with a business object;
determining identification information associated with the business object from the validation request;
obtaining historical data associated with the business object based at least in part on identification information associated with the business object, wherein the historical data includes data associated with one or more previous buyers of the business object; and
selecting at least one previous buyer from the one or more previous buyers to validate the business object.

20. The computer program product of claim 19, wherein the data associated with one or more previous buyers of the business object includes identification information associated with each of the one or more previous buyers and purchase times corresponding to the one or more previous buyers.
